(19) United States
(12) Patent Application Publication
(10) Pub. No.: US 2005/0257263 A1
(43) Pub. Date: Nov. 17, 2005

(54) Andromeda strain hacker analysis system and method

(75) Inventors: Susann Marie Keohane, Austin, TX (US); Gerald Francis McBrearty, Austin, TX (US); Shawn Patrick Mullen, Buda, TX (US); Jessica Kelley Murillo, Hutto, TX (US); Johnny Meng-Han Shieh, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/845,538

(22) Filed: May 13, 2004

(51) Int. Cl. H04L 9/00; H04L 9/32; G06F 11/30; G06F 12/14

(52) U.S. Cl. 726/22; 726/23

(57) ABSTRACT

A system and method for determining a point of immunity of a computing system to a computer virus are provided. A trace of the calls of a process, that processes a data packet which is suspected of having a computer virus, in both an infected computing system and an immune computing system are obtained. Differences in the call traces are used to pinpoint a point in the series of calls at which the processing by the two processes diverge. The process corresponding to this point of divergence is then determined and version information of the version of the corresponding process on the infected computing system and the immune computing system are determined. Differences in the version information are identified and immunization recommendations are made based on the identified differences in the version information.

### BACKGROUND OF THE INVENTION

1. Technical Field

The present invention is generally directed to an improved data processing system. More specifically, the present invention is directed to a system and method for a point of immunity of a computing system to a computer virus, as compared to other computer systems that are infected by the computer virus, so that corrective action may be taken with regard to the infected computing systems to make them immune to another computer virus attack of the same sort.

2. Description of Related Art

A computer virus, computer worm, or any malicious program or attack, which in this document will be categorically referred to as a “virus”, is a software program used to infect a computing system and cause the computing system to perform operations that are either damaging to the computing system, a network connected to the computing system, or simply an annoyance to users of the computing system and/or network. After the virus code is written, it is buried within an existing program. Once that program is executed, the virus code is activated and attaches copies of itself to other programs in the system. Infected programs copy the virus to other programs. In this way, the virus code spreads throughout the computing system and, potentially, to other computing systems via network connections.

The effect of the virus may be a simple prank that pops up a message on screen out of the blue, or it may destroy programs and data right away or on a certain date. For example, the virus can lie dormant and do its damage once a year, such as in the Michelangelo virus that contaminates the computing system on Michelangelo's birthday.

A virus cannot be attached to data. It must be attached to a runnable program that is downloaded into or installed in the computer system. The virus-attached program must be executed in order to activate the virus. Macro viruses, although hidden within documents (data), are similar. It is in the execution of the macro that the damage is done. Macro viruses constitute almost all of the viruses currently in circulation.

File attachments in e-mail messages are also suspect. If the attachment is an executable file, it can do anything when it is run.

In order to combat the increasing problem of computer viruses, many computer users employ the use of virus protection programs to detect data packets that may contain viruses and then eliminate them before the program associated with the data packet may be run. These virus protection programs rely on virus definitions being provided by a central authority that becomes aware of viruses that have been created and are infecting computer systems. These virus definitions are then used to identify data packets received in the computer system that employs the virus protection software to determine if any of these packets may be associated with a program that is infected with the virus. In this way, executable files that are infected with viruses may be identified and eliminated before they are able to damage the computer system.

While virus protection software provides a good avoidance mechanism for computer viruses, since viruses may be generated by anyone at anytime, there is some amount of delay between when a virus is first unleashed and begins to infect computing devices, and when the central authority becomes aware of the virus and generates a virus definition for the virus. Thus, a system may still be susceptible to virus attack even if virus protection software is present on the computing system.

However, viruses may be successful in attacking some computing systems while other computing systems remain immune to the attack-even when virus protection software is not being used or when virus definitions are not up to date. There may be many reasons for such immunity. One principle reason for the immunity may be that there are differences in software configurations of the computing systems that are immune and computing systems that become infected. Thus, it would be beneficial to have a system and method for identifying a point of immunity in a computing system in order determine how to make the other computing systems immune to similar virus attacks.

### SUMMARY OF THE INVENTION

The present invention provides a mechanism for determining a point of immunity of a computing system to a computer virus so that this immunity may be replicated in other computing systems that are susceptible to attack by the computer virus. When a computer virus attacks computing systems on a network of computing systems, some of these computing systems may be infected by the computer virus while others are not. The present invention is directed to understanding why one computer system may have been infected and another was not so that the apparent immunity of the non-infected computer system may be replicated on other computer systems.

The mechanism of the present invention involves identifying a payload of an incoming data packet as possibly containing a computer virus. The identification may be performed based on a pattern matching approach for identifying a pattern in a virus definition with a pattern of data in the payload of the incoming data packet or packets, for example. Such pattern matching is generally known in the art and is typically performed by known virus protection software. Based on this pattern matching, it may be determined whether a data packet contains a known computer virus or is suspected as containing a computer virus.

If an incoming data packet is identified as possibly having a computer virus in the payload of the data-packet, the data packet is routed to a listening socket which has a process listening to the socket and will process the data packet. The operating system knows the process identifier (pid) of the process that is listening on the socket because it must post a wakeup to this pid to inform the process that a data packet has arrived for processing. Thus, the pid of the process that will handle the data packet is known.

From this information it may be determined which processes handle the data packet. The method/routine calls made by these processes may be traced using a tracing mechanism, such as the kdb kernel debugger in the Advanced Interactive Executive (AIX) operating system, and the traces may be used to compare with similar traces of processes in a computing system that is immune to the computer virus, i.e. was exposed to the computer virus but did not permit the computer virus to access the computer system resources.

From a comparison of the call traces of the infected and immune computer systems, a point at which a call that is attempted by the computer virus, but is not permitted to complete successfully by the immune system, may be identified. This point in the call trace is referred to as the “point of immunity.” The process corresponding to this point of immunity may then be identified and a comparison made between the version information for this process in the infected computer system and the immune computer system. If there is a difference, it is determined that the version of the process in the infected computer system has a weakness that is exploited by the computer virus while the process in the immune computer system does not contain that weakness. Thus, the version of the process that is present on the immune computer system may be installed on the other computing systems of the network in order to replicate the immunity throughout the network.

If there is no difference between the versions of the process on the infected and immune computer systems, the individual processes called by that process may be investigated to determine any differences in versions. For example, the “what” command may be used to obtain detailed information about each process that is called by the process in which the point of immunity is identified. Based on this detailed information, differences in versions of methods/routines called may be identified and these differences may be analyzed to determine whether they contribute to the immunity of the immune computer system. As a result, this immunity may be replicated on other computer systems.

These and other features and advantages of the present invention are described in, or will be apparent to those of ordinary skill in the art in view of, the following detailed description of the preferred embodiments.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary diagram of a network data processing system in which aspects of the present invention may be implemented;

FIG. 2 is an exemplary diagram of a server data processing system in which aspects of the present invention may be implemented;

FIG. 3 is an exemplary diagram of a client data processing system in which aspects of the present invention may be implemented;

FIG. 4 is an exemplary block diagram illustrating the interaction of the primary operational components of the present invention;

FIG. 5A is an example of an Andromeda Strain hacker analysis table for a process, handling a data packet suspected of including a computer virus, in a computer system that becomes infected with the computer virus in accordance with one exemplary embodiment of the present invention;

FIG. 5B is an example of an Andromeda Strain hacker analysis table for a process, handling a data packet suspected of including a computer virus, in a computer system that is immune to the computer virus, in accordance with one exemplary embodiment of the present invention;

FIG. 6 is an example of the output of a “what” command which may be used to obtain detailed information about a process that handles a data packet suspected of including a computer virus; and

FIG. 7 is a flowchart outlining an exemplary operation of the present invention.

### DETAILED DESCRIPTION OF THE PREFERRED EMBODIMENTS

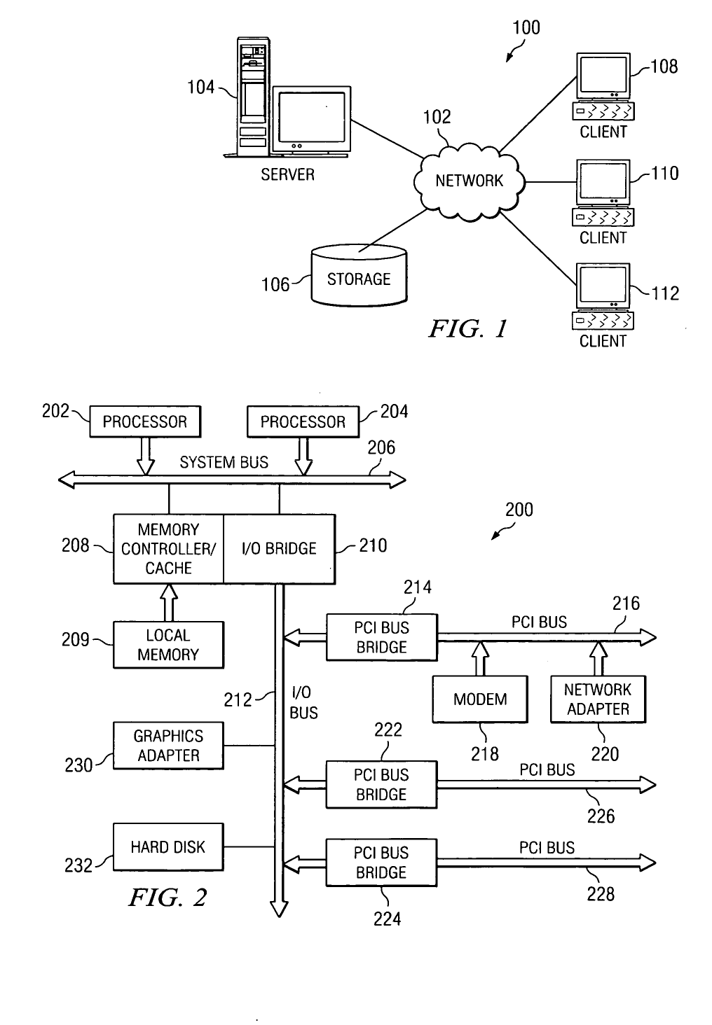

The present invention is directed to a system and method for identifying points of immunity of computing systems that are immune to a particular computer virus, computer worm, or other malicious computer based attack so that this immunity may be replicated on other computing systems (the term “virus” will be used collectively herein to refer to any computer based malicious attack on a computer system). As such, the present invention is preferably implemented in a network environment in which a plurality of computing systems are connected via one or more computer networks. In order to provide a context for the operations of the present invention discussed hereafter, the following FIGS. 1-3 are provided as a brief description of one exemplary network environment and data processing systems within the network environment. As will be appreciated by those of ordinary skill in the art, many modifications may be made to the network environment and the data processing systems without departing from the spirit and scope of the present invention.

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in connectors.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, New York, running the Advanced Interactive Executive (AIX) operating system or LINUX operating system.

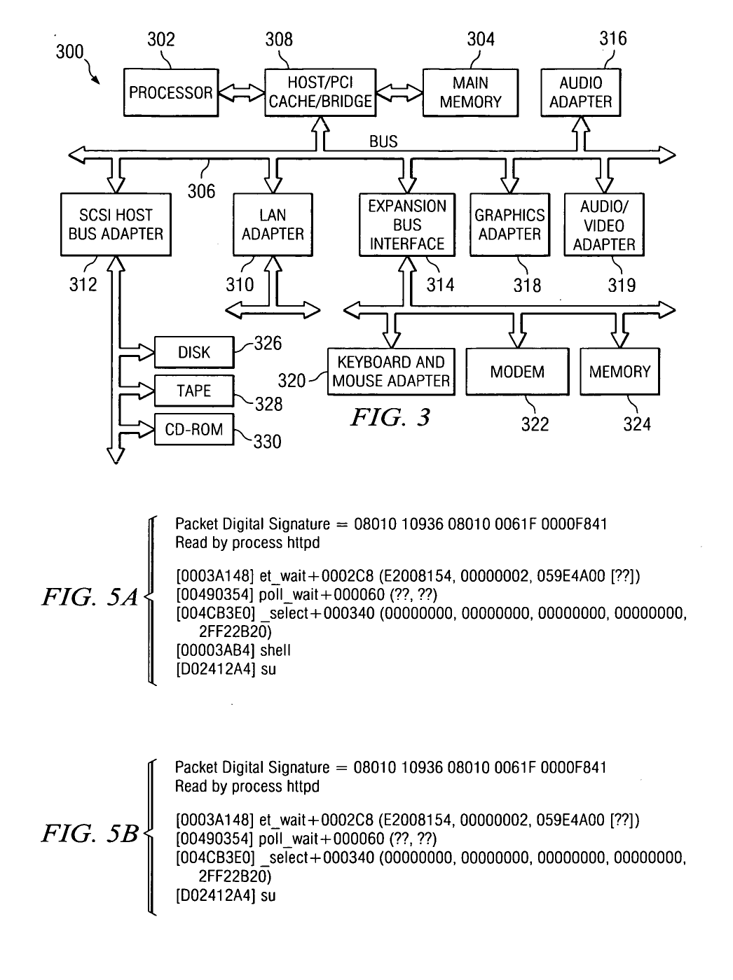

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented programming system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces. As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

As discussed above, the present invention provides a mechanism for determining why certain computing systems are immune to the effects of a computer virus while others become infected with the computer virus. The present invention provides a mechanism for identifying data packets that are suspected of having a computer virus in their payloads and a mechanism for tracing the processing of these data packets in both a computer system that is infected with the computer virus and a computer system that is immune to the computer virus. This may involve replaying or resending the data packets with the computer virus to the infected and immune computer systems and then tracing the manner in which these data packets are processed to identify the calls made by the computer virus in the infected computing system and not made in the immune computing system. In this way, a point of immunity in the immune system may be identified and then version information for the methods/routines associated with this point of immunity may be used to determine an appropriate “vaccine” for immunizing other computer systems against the computer virus.

With the system and method of the present invention, incoming data packets are passed through a stateful packet filtering mechanism that performs a pattern matching operations on the payload of the incoming packet to determine which state is associated with the data packet: a clean state, a known computer virus present state, a suspect state in which the payload is suspected of having a computer virus, and a malicious state in which the data packet is part of a malicious attack by a computer virus. The identification may be performed based on a pattern matching approach for identifying a pattern in a virus definition with a pattern of data in the payload of the incoming data packet or packets, for example. Such pattern matching is generally known in the art and is typically performed by known virus protection software.

If an incoming data packet is identified as possibly having a computer virus in the payload of the data packet, the data packet is routed to a listening socket which has a process listening to the socket and will process the data packet. The operating system of the computer system knows the process identifier (pid) of the process that is listening on the socket because it must post a wakeup to this pid to inform the process that a data packet has arrived for processing. Thus, the pid of the process that will handle the data packet is known.

From this information it may be determined which processes handle the data packet. The method/routine calls made by these processes may be traced using a debugger, such as the kdb kernel debugger in the Advanced Interactive Executive (AIX) operating system, and the traces may be used to compare with similar traces of processes in a computing system that is immune to the computer virus, i.e. was exposed to the computer virus but did not permit the computer virus to access the computer system resources.

From a comparison of the call traces of the infected and immune computer systems, a point at which a call that is attempted by the computer virus, but is not permitted to complete successfully by the immune system, may be identified. This point in the call trace is referred to as the “point of immunity.” The process corresponding to, this point of immunity may then be identified and a comparison made between the version information for this process in the infected computer system and the immune computer system. If there is a difference, it is determined that the version of the process in the infected computer system has a weakness that is exploited by the computer virus while the process in the immune computer system does not contain that weakness. Thus, the version of the process that is present on the immune computer system may be installed on the other computing systems of the network in order to replicate the immunity throughout the network.

If there is no difference between the versions of the process on the infected and immune computer systems, the individual processes called by that process may be investigated to determine any differences in versions. For example, the “what” command may be used to obtain detailed information about each process that is called by the process in which the point of immunity is identified. Based on this detailed information, differences in versions of methods/routines called may be identified and these differences may be analyzed to determine whether they contribute to the immunity of the immune computer system. As a result, this immunity may be replicated on other computer systems.

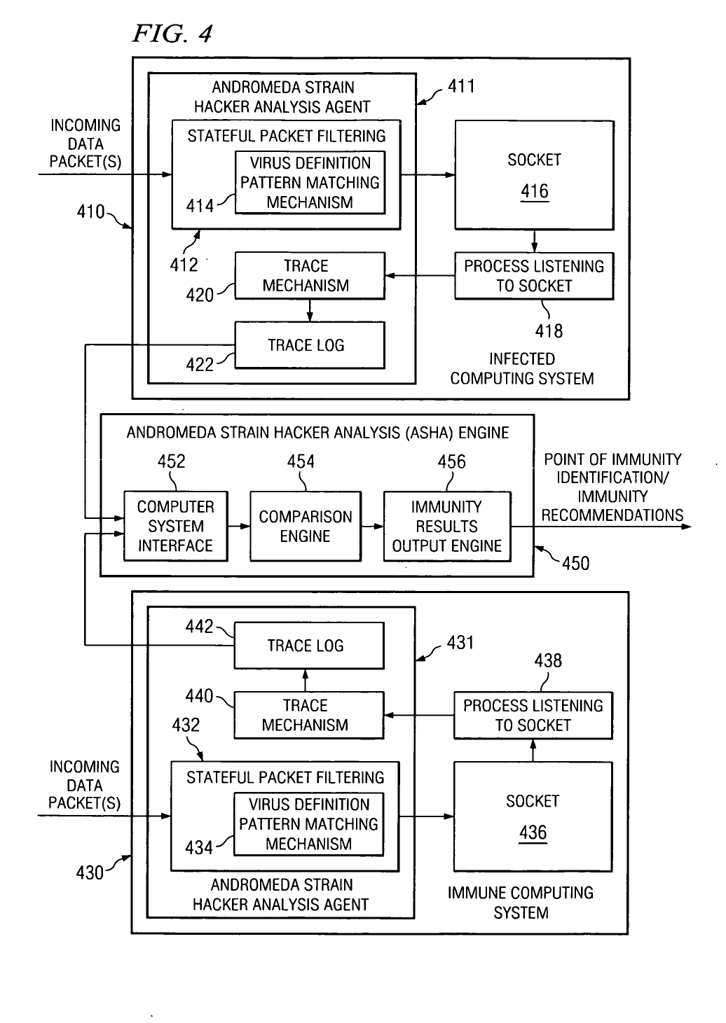

FIG. 4 is an exemplary block diagram illustrating the interaction of the primary operational components of the present invention. The operational components shown in FIG. 4 may be implemented in hardware, software, or any combination of hardware and software. In a preferred embodiment, the operational components illustrated in FIG. 4 are implemented as software running on hardware devices within computing systems.

As shown in FIG. 4, each computing system 410 and 430 includes an Andromeda Strain Hacker Analysis Agent (ASHA) 411 and 431 that is used by the present invention to filter incoming packets to determine if they are suspected of containing a computer virus and to perform a trace of the processes that process the incoming data packets. The ASHA agents provide information to the ASHA engine 450, which may be present on the same or a different computing system from one or more of the computing systems 410 and 430, which uses this information to determine a point of immunity of an immune computing system, e.g., immune computing system 430. The ASHA agents 411, 431 and the ASHA engine 450 are named after the popular book and movie “The Andromeda Strain” because a similar approach to determining the cause of an immunity to a biological viral infection is depicted in the movie and book.

The ASHA agents 411 and 431 include stateful packet filtering mechanisms 412 and 432 which are used to filter incoming packets to determine if the incoming packets possibly include computer viruses in their payloads. In the depicted example, the stateful packet filtering mechanisms 412 and 432 include virus definition pattern matching mechanisms 414 and 434 which perform pattern matching of data patterns in virus definitions to the data patterns present in incoming data packets. As discussed above, such pattern matching is generally known in the art and thus, a detailed description is not provided herein.

If the incoming data packets are determined to be “clean,” i.e. they are not suspected of having a computer virus in their payloads, the data packets are processed in a normal manner, i.e. it is routed to the appropriate socket where a process associated with the socket will process the data packet. If, however, the data packets are suspected of having a computer virus, as determined based on the pattern matching performed within the ASHA agent 411, 431, the data packet is routed to a listening socket 416, 436. The listening socket 416, 436 has a process 418, 438 listening to it, which processes data packets sent to that socket 416, 436. The process 418, 438 processes the data packets while the calls made by the process 418, 438 during processing of the data packets are traced by the trace mechanism 420. For example, a breakpoint may be associated with the address of the listening sockets 416, 436 such that when the listening sockets 416, 436 are accessed, the breakpoint permits the trace mechanism 420 to trace the calls made by the processes 418, 438.

The trace mechanism 420, 440 may be any type of trace mechanism that will provide information about the particular calls performed by a process during processing of a data packet. In a preferred embodiment, the kdb kernel debugger and kdb command are used to generate a call trace which is then stored in the trace log 422, 442. In the infected computing system 410, the trace mechanism 420 will generate a call trace that includes the calls performed by the computer virus embedded in the data packet(s) being processed. In the immune computing system 430, the call trace will not include these calls, or at least some of these calls, performed by the computer virus. This difference in the call traces is the primary indicator of the source of the immunity of the immune computing system 430.

Having generated call traces from both the infected computing system 410 and the immune computing system 430, these call traces may be provided to the ASHA engine 450 via the computer system interface 452. The call traces are compared to each other using the comparison engine 454 which parses each call trace and compares entries in the call trace of the infected computing system 410 to corresponding entries in the call trace of the immune computing system 430. If there is a difference between the call traces, the difference is noted and stored for later use in informing a system administrator of the differences. The differences may also be used to identify a point at which the computer virus takes over the processing in the infected computer system 410. The address or method/routine name provided in the call trace at this point may be used to identify a particular process that is being exploited by the computer virus to gain control of the processing of the data packet.

Once it is determined, based on the identified differences between the call traces, which process is being exploited by the computer virus, information about this process in both the infected computer system 410 and the immune computer system 430 may be used to determine what differences there are between the properties of these two processes., In a preferred embodiment, the comparison of the properties of these two processes includes comparing versions of the processes to determine if both the infected computing system 410 and the immune computing system 430 are running the same version of the process.

If the infected computing system 410 and the immune computing system 430 are not running the same version of the process, then it may be determined that the reason why the immune computing system 430 is immune to the computer virus is that the version of the process used by the immune computing system 430 does not include the weakness that is being exploited by the computer virus in the version of the process being run by the infected computer system 410. As a result, a possible “vaccine” for the computer virus is to make each of the other computing systems use the same version of the process used by the immune computer system 430. This may involve updating software on the computer systems to a newer version of the process or rolling-back updates so that an older version of the process is now utilized.

If, however, both the infected computer system 410 and the immune computer system 430 are running the same version of the process, more detailed information about the calls performed by the process may be obtained to determine if there are any differences between the processes called by the identified process. For example, the “what” command, which is known in the art, may be used to obtain detailed information about the calls and operations performed by the identified process. This detailed information includes version information for each of the methods/routines/processes called by the identified process. This information may be compared in a similar manner as discussed above to determine any differences. These differences may then be used to determine the most probable reason why the immune computing system 430 is immune to the computer virus, in a similar manner as discussed above.

The results of this comparison and analysis of the differences between the call traces may be provided by the comparison engine to the immunity results output engine 456. The immunity results output engine 456 may then generate an output identifying the point of immunity between the infected computer system 410 and the immune computer system 430 and may also provide a recommendation as to corrective action to make other computer systems immune to the computer virus, i.e. to use a particular version of a method/routine/process which appears to be immune to the computer virus.

Thus, the present invention provides a mechanism for identifying a point of immunity in a computer system that is immune to a computer virus. The identification of the point of immunity allows the identification of a particular method/routine/process that is exploited by a computer virus and a particular version of the method/routine/process that does not include the weakness exploited by the computer virus. As a result, corrective action may be taken to immunize other computer systems from the computer virus.

As mentioned above, as part of the operations performed by the ASHA agents 411 and 431, a call trace for the process 418, 438 listening to the socket 416, 436 is generated. This call trace may be generated, for example, using the kdb kernel debugger and kdb command. The result of this call trace is a ASHA table that identifies information about each call performed by the process 418, 438 that reads the incoming data packet and processes it.

FIG. 5A is an example of an andromeda strain hacker analysis (ASHA) table for a process, handling a data packet suspected of including a computer virus, in a computer system that becomes infected with the computer virus in accordance with one exemplary embodiment of the present invention. As shown in FIG. 5A, the process listening to the socket to which the data packet is directed is the “httpd” process and the digital signature of the identified virus data packet is “08010 10936 08010 0061F 0000F841.” As shown in FIG. 5A, during the processing of the data packet, there is a call to “shell.” This call is conspicuous in that the httpd process should not be calling shell. It appears that there is a buffer overflow in httpd, which would result in a call to shell, and which is a common technique used by hackers to give themselves a privileged shell on the computer system.

FIG. 5B is an example of an andromeda strain hacker (ASHA) analysis table for a process, handling a data packet suspected of including a computer virus, in a computer system that is immune to the computer virus, in accordance with one exemplary embodiment of the present invention. As shown in FIG. 5B, the call to “shell” is not present in the call trace of the ASHA analysis table. Thus, there is something in the httpd process run by the immune computer system that causes the httpd process of the immune system to not be susceptible to the attack form the computer virus.

By analyzing the process that handles the incoming packet in the manner discussed above, the call to “shell” that is present in FIG. 5A and which is not present in FIG. 5B, will be identified as a difference that may be a point of immunity for the immune computer system. For example, the httpd process being run by the immune computer system does not permit the buffer overflow, or otherwise handles the buffer overflow, such that the computer virus is unable to obtain a privileged shell. This may be due to a change in the httpd process between a version used by the infected computer system and the immune computer system. This difference in versions may be identified based on version information obtained from the operating systems for each of the httpd processes on the infected and immune computing systems. For example, by using the “what” command, detailed information about the httpd process and the other processes called by the httpd process may be obtained and used to compare between the versions of the processes run by the infected computer system and those of the immune computer system.

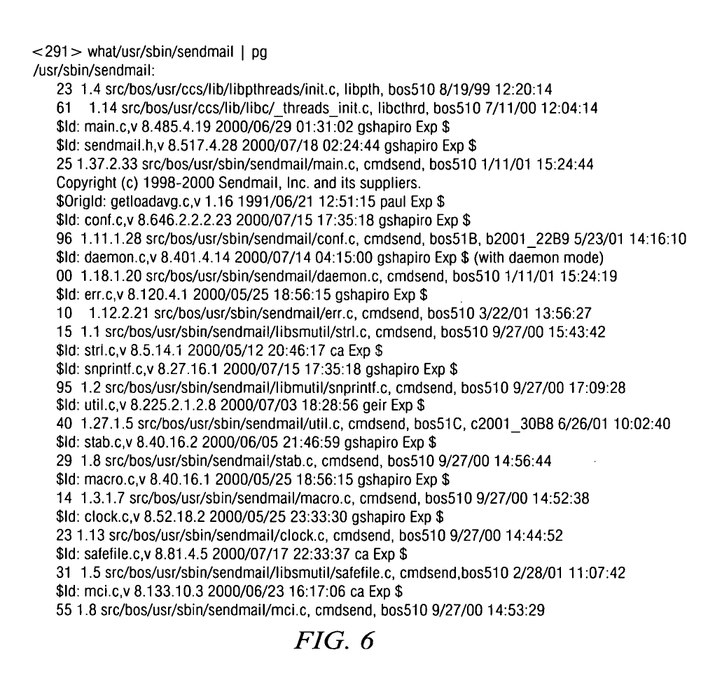

FIG. 6 is an example of the output of a “what” command which may be used to obtain detailed information about a process that handles a data packet suspected of including a computer virus. As shown in FIG. 6, the output of the “what” command is a listing of the calls made by a particular process, e.g., the “sendmail” executable program in the depicted example. The information about these calls provides the name and path of the process, the date and time the processes were compiled, and other system information. From this information, differences between versions of processes between the infected and immune computer systems may be identified through a comparison of the results of the “what” command.

From the above call traces and the “what” command results, a determination may be made as to a point at which the immune computer system does not permit access to the computer system by the computer virus. This point, e.g. a call to a method/routine/process/library that is not permitted, may then be used to determine what version of the corresponding process is immune to the computer virus. This information along with a recommendation regarding immunization of other computing systems may then be presented to a system administrator or other user.

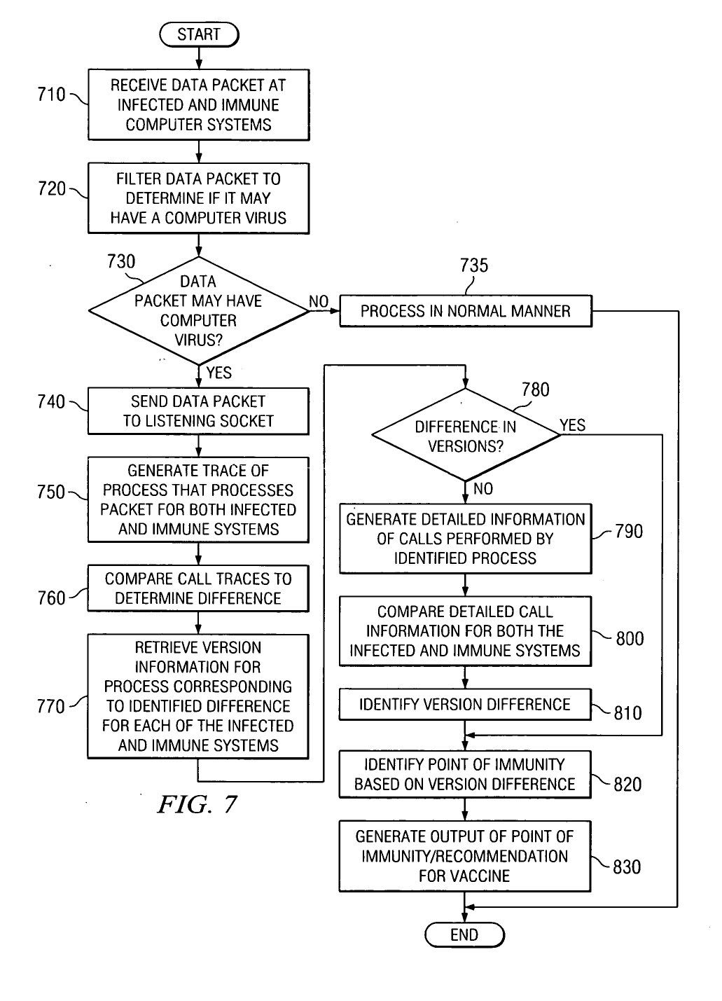

FIG. 7 is a flowchart outlining an exemplary operation of one exemplary embodiment of the present invention. It will be understood that each block of the flowchart illustration, and combinations of blocks in the flowchart illustration, can be implemented by computer program instructions. These computer program instructions may be provided to a processor or other programmable data processing apparatus to produce a machine, such that the instructions which execute on the processor or other programmable data processing apparatus create means for implementing the functions specified in the flowchart block or blocks. These computer program instructions may also be stored in a computer-readable memory or storage medium that can direct a processor or other programmable data processing apparatus to function in a particular manner, such that the instructions stored in the computer-readable memory or storage medium produce an article of manufacture including instruction means which implement the functions specified in the flowchart block or blocks.

Accordingly, blocks of the flowchart illustration support combinations of means for performing the specified functions, combinations of steps for performing the specified functions and program instruction means for performing the specified functions. It will also be understood that each block of the flowchart illustration, and combinations of blocks in the flowchart illustration, can be implemented by special purpose hardware-based computer systems which perform the specified functions or steps, or by combinations of special purpose hardware and computer instructions.

As shown in FIG. 7, the operation starts by receiving a data packet, or packets, at the infected and immune computing systems (step 710). The data packet(s) are filtered to determine if they are suspected of having a computer virus in their payloads (step 720). A determination is made as to whether the data packet may have a computer virus (step 730). If not, the data packet(s) are processed in a normal manner (step 735). Otherwise, if the data packets are suspected of having a computer virus, the data packets are sent to a listening socket which has a process whose calls will be traced listening to the listening socket (step 740).

A trace of the calls performed by the processes that process the data packet on both the infected and immune computer systems is generated (step 750) and compared to determine differences (step 760). Version information is then retrieved for the processes corresponding to the identified differences for each of the infected and immune systems (step 770). A determination is then made as to whether there are any differences in the version information (step 780).

If not, detailed information about the calls performed by the identified process on each of the infected and immune computer systems is generated (step 790). This may be done, for example, using the “what” command as discussed above. This detailed information is then compared (step 800) to determine any differences between version information for processes called by the identified process (step 810). Thereafter, or if there are differences in the versions of the identified processes in step 780, the point of immunity for the immune computing system is identified based on differences in version information (step 820). An output of the point of immunity and/or recommendations for a vaccine for other computing devices is then output (step 830). The operation then terminates.

Thus, the present invention provides an automated mechanism for identifying a point of immunity of a computer system that is immune to the effects of a computer virus while other computer systems having a similar configuration become infected by the computer virus. The identification of the point of immunity makes it possible for a “vaccine” to be identified to immunize the other computer systems from this computer virus. As a result, the computer systems are made less susceptible to malicious attacks.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method, in a data processing system, for identifying a point of immunity to a computer based attack, comprising:
generating a first call trace of a first process, in an infectable computer system, that processes a data packet suspected of being associated with a computer based attack;
generating a second call trace of a second process, comparable to the first process, in an immune computer system, that processes the data packet suspected of being associated with a computer based attack;
comparing the first call trace to the second call trace; and
determining a point of immunity based on results of the comparison of the first call trace to the second call trace.

2. The method of claim 1, wherein the first process and the second process are a same process but in different computer systems.

3. The method of claim 1, wherein determining a point of immunity based on the results of the comparison includes:
identifying a process associated with a difference between the first call trace and the second call trace to thereby generate an identified process;
retrieving first process information about the identified process from the infectable computer system;
retrieving second process information about the identified process from the immune computer system; and
identifying differences between the first process information and the second process information.

4. The method of claim 3, wherein the first process information and the second process information include version information for the identified process.

5. The method of claim 3, wherein the first process information and second process information include a compile time for the identified process.

6. The method of claim 3, wherein the first process information and second process information include detailed version information about processes called by the identified process.

7. The method of claim 6, wherein the detailed version information about the processes called by the identified process is obtained using a “what” command.

8. The method of claim 1, wherein the first call trace and the second call trace are obtained using a kernel debugger on the infectable computer system and the immune computer system, respectively.

9. The method of claim 1, further comprising:
generating an output to a workstation identifying the point of immunity.

10. The method of claim 9, wherein the output includes a recommendation for replicating the point of immunity in other computer systems.

11. A computer program product in a computer readable medium for identifying a point of immunity to a computer based attack, comprising:
first instructions for generating a first call trace of a first process, in an infectable computer system, that processes a data packet suspected of being associated with a computer based attack;
second instructions for generating a second call trace of a second process, comparable to the first process, in an immune computer system, that processes the data packet suspected of being associated with a computer based attack;
third instructions for comparing the first call trace to the second call trace; and
fourth instructions for determining a point of immunity based on results of the comparison of the first call trace to the second call trace.

12. The computer program product of claim 11, wherein the first process and the second process are a same process but in different computer systems.

13. The computer program product of claim 11, wherein the fourth instructions for determining a point of immunity based on the results of the comparison include:
instructions for identifying a process associated with a difference between the first call trace and the second call trace to thereby generate an identified process;
instructions for retrieving first process information about the identified process from the infectable computer system;
instructions for retrieving second process information about the identified process from the immune computer system; and
instructions for identifying differences between the first process information and the second process information.

14. The computer program product of claim 13, wherein the first process information and the second process information include version information for the identified process.

15. The computer program product of claim 13, wherein the first process information and second process information include a compile time for the identified process.

16. The computer program product of claim 13, wherein the first process information and second process information include detailed version information about processes called by the identified process.

17. The computer program product of claim 16, wherein the detailed version information about the processes called by the identified process is obtained using a “what” command.

18. The computer program product of claim 11, wherein the first call trace and the second call trace are obtained using a kernel debugger on the infectable computer system and the immune computer system, respectively.

19. The computer program product of claim 11, further comprising:
fifth instructions for generating an output to a workstation identifying the point of immunity.

20. A system for identifying a point of immunity to a computer based attack, comprising:
means for generating a first call trace of a first process, in an infectable computer system, that processes a data packet suspected of being associated with a computer based attack;
means for generating a second call trace of a second process, comparable to the fist process, in an immune computer system, that processes the data packet suspected of being associated with a computer based attack;
means for comparing the first call trace to the second call trace; and
means for determining a point of immunity based on results of the comparison of the first call trace to the second call trace.
